(19) United States
(12) Patent Application Publication
(10) Pub. No.: US 2007/0179902 A1
(43) Pub. Date: Aug. 2, 2007

(54) Printing apparatus system and method

(76) Inventor: Kenneth St. John, Norwich, NY (US)

Correspondence Address: SCHMEISER, OLSEN & WATTS, 22 CENTURY HILL DRIVE, SUITE 302, LATHAM, NY, 12110, US

(21) Appl. No.: 11/344,786

(22) Filed: Feb. 1, 2006

(51) Int. Cl. G06Q 99/00; H04L 9/00

(52) U.S. Cl. 705/62

(57) ABSTRACT

A printing apparatus, system and method is provided, wherein the printing apparatus includes an imager and a verifier and prints images, such as postage indicia including addressee information on a material such as a mail piece. The apparatus verifies whether the images, such as postage indicia, printed on the material, such as a mail piece, accurately depict the images, such as postage indicia including addressee information and compares the verified image information with additional information pertaining to images to be printed on the material. The apparatus prints the additional information on the mail piece if it matches the compared verified printed image information.

### BACKGROUND OF INVENTION

1. Technical Field

This invention relates generally to the field of printing. More particularly, this invention provides for an apparatus system and method for printing images and verifying accuracy of images printed.

2. Related Art

Often, images printed on various materials represent information symbolically intended to be displayed on the materials. For example, postage is representative of the charge for mailing an item and it is critical that the postage printed on a mail piece be authentic so that mailing costs may be remunerated. Accordingly, postal carriers such as the United States Postal Service (USPS) have constructed various protocols to ensure that postage provided on mail items accurately reflects charges associated with handling and delivering the items. For example, postage indicia have been designed to deter fraudulent replication by uniquely including, inter alia, specific information pertaining to the mailing charge, the mailing entity, the mail piece, its origin and/or its destination. The information provided in the postage indicia may be encrypted for greater security. Furthermore, postal carries such as the USPS often require that postage charges be pre-paid prior to printing the postage indicia on a mail piece in order to make more certain that the postage is correctly accounted.

To accommodate the various postage protocols mandated by postal carriers, postage metering devices, systems and methods have been introduced to print postage indicia and accommodate for associative postal charges relative to the mailing of mail pieces. However, common metering devices, systems and methods suffer from inefficiencies and wastefulness if or when printing errors occur following the pre-payment of postage charges. For example, if the postage indicia printed on a mail piece is blurred or in some other manner is physically unacceptable then although the corresponding postal charge has been pre-paid the postage is still inoperative because of the faulty printing. Therefore, pre-paid charges may be wasted if the associated postage is not printed accurately. Moreover, if the postage indicia printed on a mail piece includes information pertaining to the intended mailing recipient, the mail piece may become unacceptable and non-deliverable if the printed postage does not ultimately match the related recipient address printed on the mail piece. For instance, if the postal charges of a bulk mailing have been pre-paid and a batch of mail pieces has had printed postage affixed, then the intended mail recipient information must match any addressee information previously incorporated in the printed postage indicia. Thus if an error occurs rendering a mismatch, such as the printing of an address on a mail piece that does not directly compliment associated recipient information previously printed in the postage, then the mail piece may be unacceptable. Where the entire batch of mail pieces is printed consecutively, a single mismatch may propagate a recurring error through each successive printing, thereby rendering the entire batch of postal items unacceptable and non-deliverable. Hence, although the postal charges for the batch were pre-paid, the mail items may not be acceptable and the pre-paid postage may be wasted.

Accordingly, there is a need in the field of printing for an improved apparatus system and method for printing images, such as postage indicia, and verifying accuracy of images printed.

### SUMMARY OF INVENTION

The present invention provides an apparatus system and method for printing and verifying that offers improved reliability.

A first general aspect of the invention provides a postage printing apparatus comprising: a processor including governing protocol executable for imaging and verifying; an input, communicatively operable with the processor and configured to receive data pertaining to postage indicia and corresponding mail destination information, said postage indicia including addressee information and said mail destination information including intended recipient information; a first imager, configured to print postage indicia on a mail piece as directed by the governing protocol of the processor; a verifier, configured to scan postage indicia printed by the imager on the mail piece and communicate indicia scan data to the processor, wherein the processor executes the governing protocol to evaluate the indicia scan data to determine if addressee information is apparent in the indicia scan data and to compare apparent addressee information with corresponding intended recipient information included in the mail destination information inputted to the processor to confirm that the addressee information matches the intended recipient information; a second imager, configured to print mail destination information as directed by the governing protocol of the processor only following said processor's confirmation that the addressee information apparent in the indicia scan data matches intended recipient information; and an indicator, operable with the processor and configured to provide an alert as to whether the addressee information apparent in the indicia scan data does not match the intended recipient information.

A second general aspect of the invention provides a postage printing method comprising: obtaining a data set, said data set including postage data and mail destination data; printing postage indicia on a mail piece, wherein said postage indicia includes addressee information pertinent to the obtained postage data; verifying whether the postage indicia printed on the mail piece accurately depicts the addressee information; comparing the verified addressee information with intended recipient information included in corresponding mail destination data to determine whether the addressee information authentically matches the intended recipient information; and printing only the authenticated intended recipient information on the mail piece.

A third general aspect of the invention provides a postage printing system comprising: a printing apparatus having an imager and a verifier, wherein the printing apparatus performs the steps of: printing postage indicia on a mail piece, wherein said postage indicia includes addressee information; verifying whether the postage indicia printed on the mail piece accurately depicts the addressee information; comparing the verified addressee information with intended recipient information to be printed on the mail piece; and printing the intended recipient information on the mail piece if it matches the compared verified addressee information.

A fourth general aspect of the invention provides a printing apparatus comprising: a processor including governing protocol executable for imaging and verifying; an input, communicatively operable with the processor and configured to receive data pertaining to first image information and second image information, said first image information pertaining to a first image and said second image pertaining to a second image; a first imager, configured to print said first image on a material as directed by the governing protocol of the processor; a verifier, configured to scan said first image printed by the imager on the material and communicate image scan data to the processor, wherein the processor executes the governing protocol to evaluate the image scan data to determine if first image information is apparent in the image scan data and to compare apparent first image information with corresponding second image information inputted to the processor to confirm that the apparent first image information matches the second image information; a second imager, configured to print a second image as directed by the governing protocol of the processor only following said processor's confirmation that the first image information apparent in the image scan data matches second image information; and an indicator, operable with the processor and configured to provide an alert as to whether the first image information apparent in the image scan data does not match the second image information.

The foregoing and other features of the invention will be apparent from the following more particular description of various embodiments of the invention.

### BRIEF DESCRIPTION OF THE DRAWINGS

Some of the embodiments of this invention will be described in detail, with reference to the following figures, wherein like designations denote like members, wherein:

FIG. 1 depicts a front view of an embodiment of a printing apparatus, in accordance with the present invention;

FIG. 2 depicts a partially cutaway side view of an embodiment of a printing apparatus having a computer slidably exposed, in accordance with the present invention;

FIG. 3 depicts a partially cutaway side view of an embodiment of a printing apparatus having a computer slidably concealed, in accordance with the present invention;

FIG. 4 depicts a top view of an embodiment of a printing apparatus, in accordance with the present invention;

FIG. 5 depicts a schematic view of an embodiment of a product sensing system of an embodiment of a printing apparatus, in accordance with the present invention;

FIG. 6 depicts a side view of an embodiment of a height adjustment detail of an embodiment of printing apparatus, in accordance with the present invention;

FIG. 7 depicts a front view of an embodiment of a control panel of an embodiment of a printing apparatus, in accordance with the present invention;

FIG. 8 depicts a flow chart of an embodiment of methodology relative to the initiation of postage printing, in accordance with the present invention;

FIG. 9 depicts a flow chart of an embodiment of methodology of manipulating postage indicia data correlative to postage printing, in accordance with the present invention;

FIG. 10 depicts a flow chart of an embodiment of methodology relative to postage printing including checking for postage on a list, in accordance with the present invention;

FIG. 11 depicts a flow chart of an embodiment of methodology for postage printing, in accordance with the present invention; and

FIG. 12 depicts a flow chart of an embodiment of methodology relative to the termination of postage printing, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

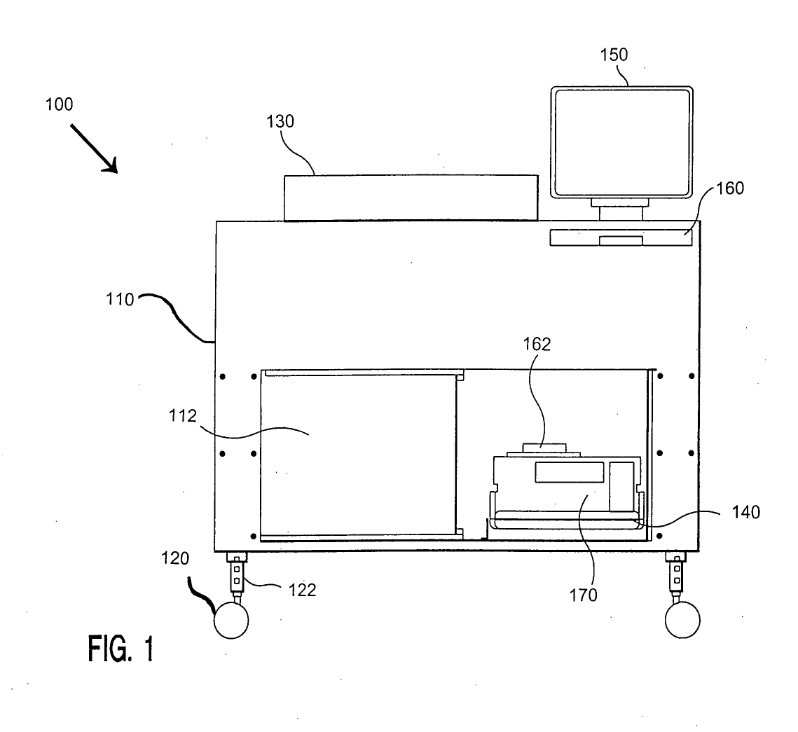

Referring to the drawings, FIG. 1 depicts a front view of an embodiment of a printing apparatus 100, in accordance with the present invention. The printing apparatus 100 may be configured to print images, such as postage indicia, text, wherein the text may be standard type face deposited in any language or fanciful font in any/all colors. Moreover the images may be bar-codes, postage symbols, graphical images, icons, photographic images, and other similar images, wherein the images may have one or multiple colors, hues, and/or degrees of print density. The printing apparatus 100 may be a stand alone work station or may be integrated into other printing facilities and devices. For example, two or more printing apparatuses 100 may be physically and electrically linked together to accomplish printing of images in accordance with the invention. As a stand alone work station, the printing apparatus 100 may be physically fixed in one location or may be movable. For instance, the printing apparatus may include rollers 120 positioned at its base to facilitate movement of the apparatus 100. Moreover, the rollers, or other elemental features of the base may be height adjustable, having resilient members 120 cooperating with detents or holes to provide secure versatility to the performance capability of the apparatus 100.

The printing apparatus 100 may include a housing 110, generally located about the apparatus 100 to contain and/or provide structural support to various component features of the apparatus 100. Operable with the housing may be a sliding door 112 that may be manipulated to reveal internal components such as a computer 170 and wireless mouse input 162. The computer 170 may be located on a slide-out tray 140 or other similar component for providing easy access to the computer. Furthermore, the printing apparatus 100 may include a computer monitor 150 or other visual display. The computer monitor 150 may be operable with the computer 170. In addition, the printing apparatus 100 may include a keyboard input 160, which also may be operable with the computer 170. Still further the printing apparatus may include a lid or cover 130 to protect the top part of the apparatus 100. The lid or cover 130 may be clear or opaque. For example, the lid or cover 130 may be formed of clear Lexan plastic.

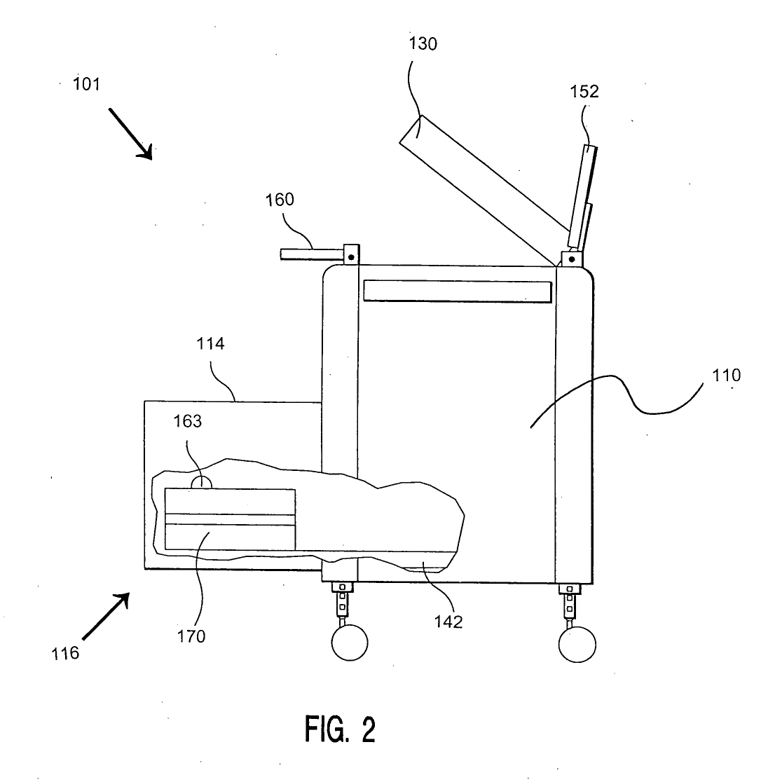

With continued reference to the drawings, FIG. 2 depicts a partially cutaway side view of an embodiment of a printing apparatus 101 having a computer 170 slidably exposed, in accordance with the present invention. The computer 170 may be positioned on a slide-out tray 140 (not shown) which may operate with a tray rail 142. Accordingly, an operator may open the cabinet door 114 and expose the computer 170 by sliding it out as it is positioned on the tray 140 being functional with the tray rail 142. When exposed without the housing 110, the computer 170 may be located in a first position 116. Furthermore, the printing apparatus 101 may include a flat screen monitor 152, a keyboard input 160 and a hardline mouse input 163. As depicted, the lid or cover 130 of the apparatus 101 is shown in an up position being rotatable about hinges placed in the rear of the top portion of the apparatus 101. However, those in the art should appreciate that other feasible mechanical configurations may be implemented to provide movement to the lid or cover 130.

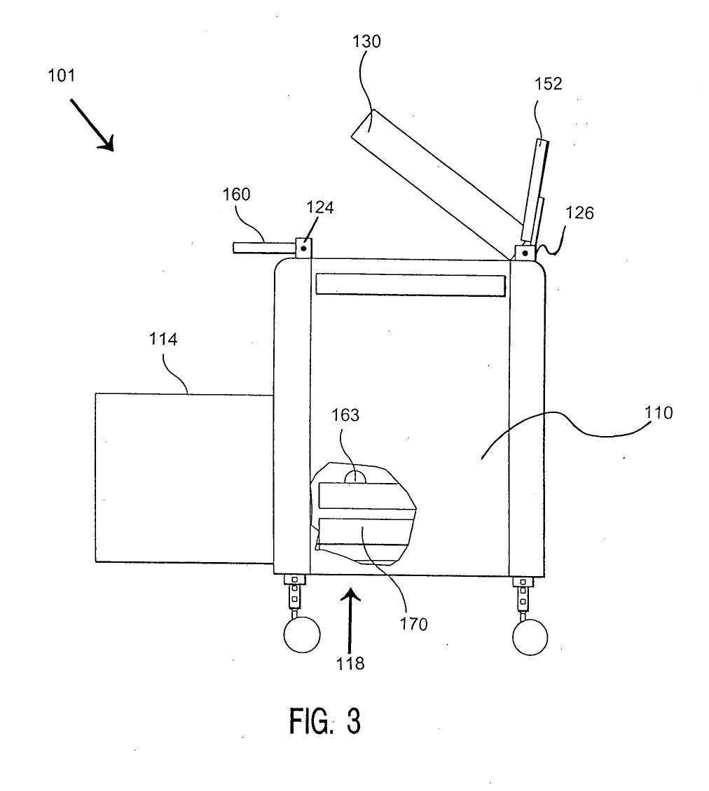

Referring to FIG. 3, which depicts a partially cutaway side view of an embodiment of a printing apparatus 101 having a computer 170 slidably concealed, in accordance with the present invention, the concealment may include location of the computer 170 in a second position 118, wherein the computer 170 is located on a tray 140 (not shown) that is slid along a rail 142 into the housing 110. Those in the art should recognize that the door 114 may be closed so that the computer is completely concealed when residing in a second position 118 within the housing 110. The mouse 163 may also be concealed within the housing 110 when the door 114 is shut. In addition, the postage printing apparatus 101 may include a releasable/movable keyboard couple 124 for releasably/movably attaching the keyboard input 160 to the apparatus 101. Moreover, the printing apparatus 101 may also include a releasable/movable monitor couple 126 for releasably/movably attaching the monitor 152 to the apparatus 101. Though not shown, it should also be recognized that the lid or cover 130 may also be releasably/movably attached to the apparatus 101. Furthermore, various portions of the housing 110, such as panel sections, may also be configured to releasably attach to the printing apparatus 101.

The computer 170 or similar computing unit of the printing apparatus 100 or 101, or other similar embodiments, may generally comprise and house central processing unit (CPU) or processor, a memory, an input/output (I/O) interface, a bus, I/O devices and a storage unit. The processor performs computation and control functions of the computer 170. The computer 170 processor may comprise a single processing unit, or be operably distributed across one or more processing units in one or more locations (e.g., on a client and server). The computer 170 memory may comprise any known type of data storage and/or transmission media, including magnetic media, optical media, random access memory (RAM), read-only memory (ROM), a data cache, a data object, etc. The computer 170 storage unit is, for example, a magnetic disk drive or an optical disk drive. Moreover, similar to the processor, the computer 170 memory may reside at a single physical location, comprising one or more types of data storage, or be distributed across a plurality of physical systems in various forms. Further, the computer 170 memory can include data distributed across, for example, a local area network LAN, a wireless area network WAN or storage area network (SAN)

The computer 170 input or I/O interface may comprise any system for exchanging information to or from an external source. I/O devices may comprise any known type of device, including a display monitor, keyboard, mouse, a GUI interface, a wireless port, a hardline port, and a drive capable of reading retrievable media, printer, speakers, handheld device, facsimile, etc. A bus may provide a communication link between each of the components in computer 170, and may comprise any type of transmission link, including electrical, optical, wireless, ultrasonic, etc.

The input allows the processor of the computer 170 of the postage printing apparatus 100 to store and retrieve information (e.g., program instructions, governing protocol, or data and/or data sets, such as postage data and/or mail destination data) from an auxiliary storage device, such as a non-volatile storage device (e.g., a CD-ROM drive which receives a CD-ROM disk) (not shown) and/or from external processors. The processor of the computer 170 can store and retrieve information from other auxiliary storage devices (not shown), which can include a direct access storage device (DASD) (e.g., hard disk or floppy diskette), a magneto-optical disk drive, a tape drive, or a wireless communication device. Moreover the input may be communicatively operable with the processor and configured to receive data, such as data pertaining to postage indicia and corresponding mail destination information, said postage indicia including addressee information and said mail destination information including intended recipient information.

The memory of the computer 170 may include computer program code or other governing protocol comprising a query generation system that may generate schema mapping-based queries that provide instances of target schemas that are without duplicate elements and satisfy PNF requirements. Governing protocol may be executable for imaging and verifying. Further, the memory of the computer 170 may include other systems not shown in the drawings, such as an operating system (e.g., Linux, or Microsoft Windows XP) that runs on the processor and provides control of various components within and/or connected to the computer 170 and/or the printing apparatus 100 or 101.

Elements of the invention can take the form of an entirely hardware embodiment, an entirely software embodiment or an embodiment containing both hardware and software elements. Furthermore, elements of the invention can take the form of a computer program product accessible from a computer-usable or computer-readable medium providing program code or governing protocol for use by or in connection with a processor or CPU or any instruction execution system to provide and facilitate the capabilities of the present invention. For the purposes of this description, a computer-usable or computer-readable medium can be any apparatus that can contain, store, communicate, propagate, or transport the governing protocol for use by or in connection with the instruction execution system, apparatus, or device.

The medium can be an electronic, magnetic, optical, sonic, electromagnetic, infrared, or semiconductor system (or apparatus or device) or a propagation medium. Examples of a computer-readable medium include a semiconductor or solid state memory, magnetic tape, a removable computer diskette, RAM, ROM, a rigid magnetic disk, a memory stick and an optical disk. Current examples of optical disks include compact disk-read-only memory (CD-ROM), compact disk-read/write (CD-R/W) and DVD.

A processor of an embodiment of a printing apparatus 100 or 101 suitable for storing and/or executing governing protocol, such as program code for directing processing operations, includes at least one processor circuit coupled directly or indirectly to memory elements through a system bus. The memory elements can include local memory employed during actual execution of the governing protocol, bulk storage, and cache memories which provide temporary storage of at least some governing protocol, such as program code in order to reduce the number of times code must be retrieved from bulk storage during execution.

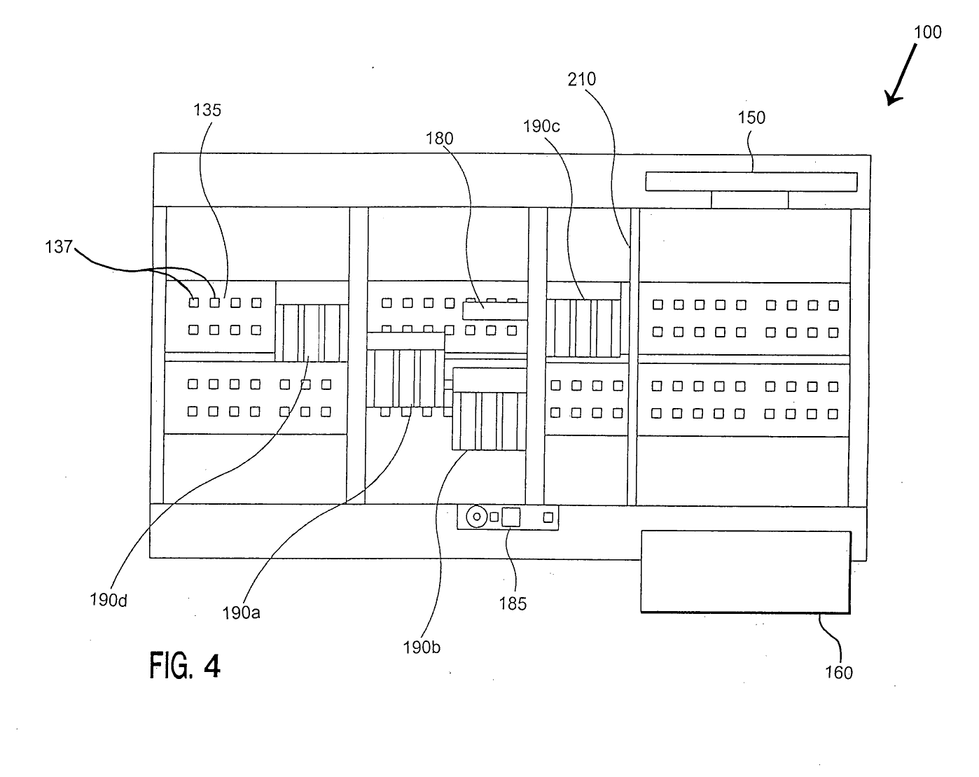

With continued reference to the drawings, FIG. 4 depicts a top view of an embodiment of a printing apparatus 100, in accordance with the present invention. The printing apparatus 100 may include a transporter 135 such as a mail piece conveyer comprising a belt or other mechanical implement that may effectively convey mail pieces or other materials to be printed on about the printing apparatus 100 during printing. However, those in the art may appreciate that the printing apparatus 100 may be designed such that materials to be printed on, such as mail pieces, for example, may remain stationary while other components such as imagers and verifiers are moved to accomplish printing. The transporter 135 may include holding means such as vacuum suction that may be provided through spaced apart holes 137 in the transporter 135. Those in the art should appreciate that mechanical implements such as catches, flaps, and/or resilient members or like implements may also be utilized to hold the materials to be printed on, such as paper, credit cards, compact disks or mail pieces, in place during printing. The transporter 135 may carry materials to be printed on, such as mail pieces, from one end of the postage printing apparatus 100 to the other. Moreover, materials to be printed on may be carried in multiple directions by the transporter 135.

Located at various positions with respect to the transporter 135 may be an imager 190a or several imagers 190a-d. The location of the imagers 190a-d should be such that materials to be printed on, such as paper products, credit cards, compact disks, mail pieces or other articles being conveyed by the transporter 135 may be positioned so that the imagers 190a-d may readily print images on the materials to be printed on. The images printable by the imagers may include, but are not limited to, postage indicia, alphanumeric symbols, typographic symbols, photographic images, icons, computer enhanced images and/or other images capable of being printed on materials such as mail pieces, paper products, credit cards, compact disks, cloth, synthetic products metals, composites, and/or other like materials and/or combinations of materials. A first imager, such as imager 190c, may be configured to print images, such as postage indicia, on a material to be printed on, such a mail piece, as directed by the governing protocol of the processor.

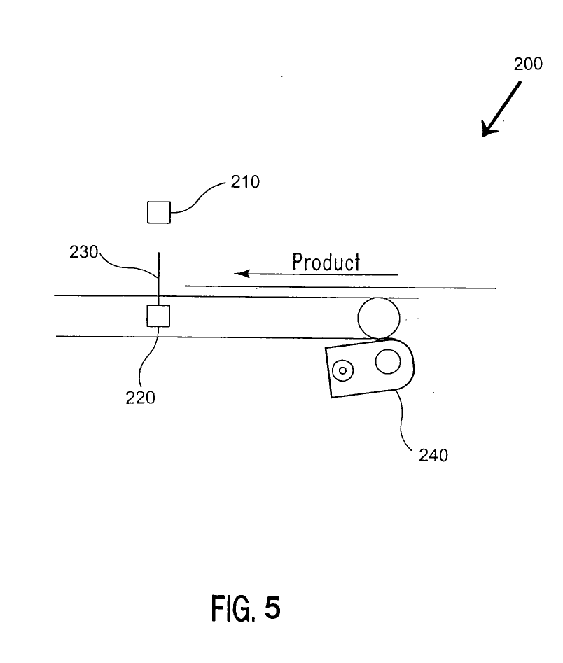

Referring further to FIG. 4, a printing apparatus 100 may include a verifier 180. The verifier 180 may be operable with the transporter 135 and may be pulsed on and off based on the precise position (as determined by sensors and encoders discussed in greater detail in reference to FIG. 5) of the printed images to be scanned. The verifier 180 may be configured to scan images, such as postage indicia or photographs, or other images printed by the imager(s) 190a-d on the materials to be printed on, such as mail pieces, and communicate the scan data corresponding scanned images to the processor, wherein the processor may execute the governing protocol to evaluate the image scan data to determine if information pertinent to the image, such as addressee information, is apparent in the image scan data. Moreover, the processor may execute the governing protocol to compare that scanned pertinent image information, such as apparent addressee information of postage indicia, and determine whether the scanned pertinent image information corresponds with information pertinent to future images to be printed, wherein the images to be printed may contain information, such as intended recipient information possibly included in the mail destination information and inputted to the processor, and to confirm that the scanned pertinent information, such as addressee information, matches the information pertinent to future images to be printed, such as intended recipient information. The verifier's 180 output may be linked to the processor and directed and responded to by the processor to insure that its' read data is correct and to verify whether the images, such as postage indicia, printed on the materials to be printed on, such as mail pieces, accurately depicts the scanned pertinent image information, such as addressee information. Moreover, the tracking of the printed images, such as postage indicia, themselves may be utilized to trigger the scanning operations of the verifier 180; in other words, the triggering of the verifier 180 may be linked to the locatable tracing of the previously printed images, such as postage indicia, as opposed to the finding of a lead edge or a separate and distinct mark on the material to be printed on, such as a mail piece.

A second imager, such as imager 190a, may be configured to print other images. For example the second imager may print images such as intended recipient images associated with mail destination information as directed by the governing protocol of the processor. However, the printing by the second imager, such as imager 190a, may occur only following the processor's confirmation that information pertinent to the previously printed images, such as the addressee information apparent in the indicia scan data authentically matches information pertinent to future images to be printed such as intended recipient information images. Hence the second imager, such as imager 190a, may be configured to only print authenticated images. For example the second imager may be configured to print only print authenticated intended recipient information on the mail piece. Authenticated information may be information that has been compared against verified printed information pertinent to printed images and is found to be matching with information pertinent to future images to be printed.

Referring further still to FIG. 4, the printing apparatus 100 may include a control panel 185. The control panel may provide operator ability to control the printing process. Furthermore, the printing apparatus 100 may include a print product sensor detector bar 210. Moreover, the monitor 150 may be utilized to provide information relative to the printing process. Additionally, the keyboard input 160 may operate with the control panel to affect the printing process.

With continued reference to the drawings, FIG. 5 depicts a schematic view of an embodiment of a print product sensing system 200 of an embodiment of a printing apparatus 100, in accordance with the present invention. The print product sensing system 200 may include a detector bar 210 working in conjunction with an emitter 220 to detect print products or materials to be printed on. The emitter 220 may emit any electromagnetic emission 230, such as a light beam and/or sonic emission. The detector bar may be configured to detect the emissions from the emitter 220. Additionally, the detector bar need not be a physical bar, but may be any device capable of detecting the emissions from the emitter 220. The print product sensing system 200 may also include an encoder 240. The encoder may be a bar code reader, camera, or other similar implement that may be able to track, trace, scan and/or identify images, such as postage indicia and other printed images. The emitter 220, detector 210 and/or encoder 240 may be stationary, or may be moveable to accomplish the objects of the invention.

The print product sensing system 200 may work in conjunction with the verifier 180 to facilitate the authentication of information pertinent to printed images, such as addressee information pertinent to printed postage indicia as correlative with information pertinent to images to be printed in the future, such as intended mail recipient information of mail destination data. The output of the various component elements individually or as a whole of the print product sensing system 200 output may be linked to the governing print control processor to insure that the system's output data is correct.

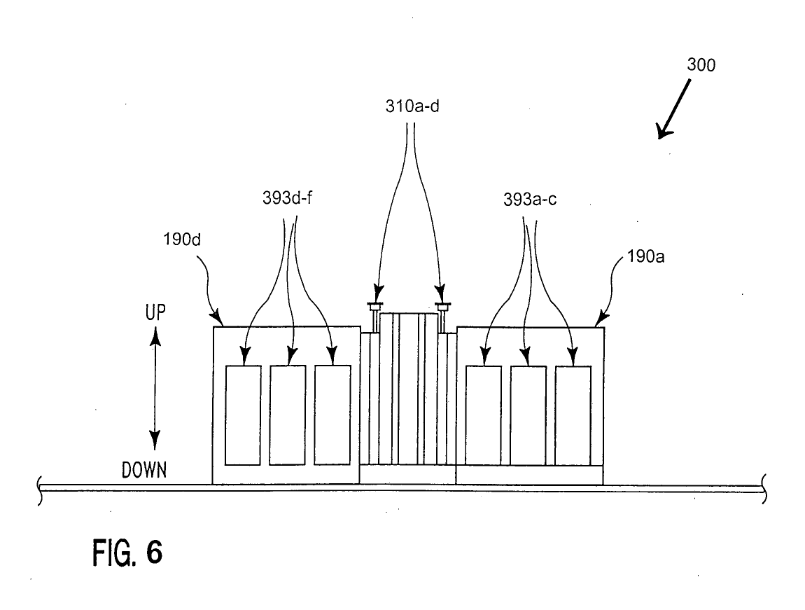

With additional reference to the drawings, FIG. 6 depicts a side view of an embodiment of a height adjustment detail 300 of an embodiment of printing apparatus 100, in accordance with the present invention. The height adjustment detail 300 may include height adjustment knobs 310a-d, which may adjust the height of imagers 190a-d. The imagers 190a-d may each include ink cartridges. For example, imager 190a may include three ink cartridges 393a-c, where imager 190d may include three different ink cartridges 393d-f. The ink cartridges may contain various inks of various colors, wherein the ink is operable to be efficiently and fixedly printed on materials to be printed on such as paper product, a mail piece, credit cards, compact disks or other products that may be printed on.

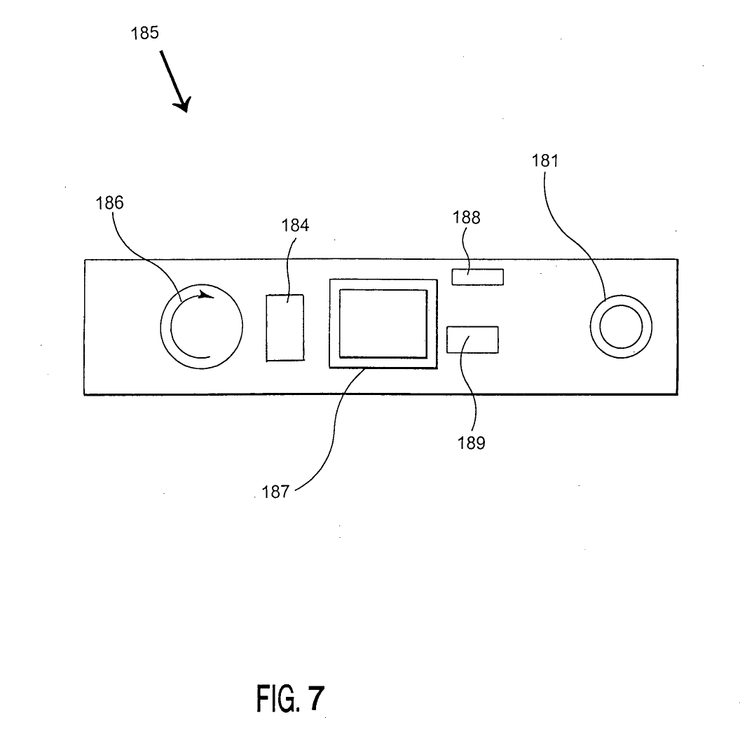

The front view of an embodiment of a control panel 185, of an embodiment of a printing apparatus 100, as shown in FIG. 7, reveals that the control panel may include a print product, such as a mail piece, movement adjustment knob 186, an on/off button 187 and corresponding on and off lights 188 and 189 respectively which shine to indicate the state of the printing apparatus 100 as either on or off. Moreover, the control panel 185 may also include a removably attachable I Button 184. The I Button 184, may include software directives and have stored information that operates with the governing protocol of the processor of the computer 170 to assist in print job security. For example, the I Button 184 may provide a key necessary for decrypting an encrypted print job. Furthermore, the control panel 185 may also include an indicator 181 manifest as an amber colored light. The indicator 181 may be operable with the processor of the computer 170 and be configured to provide an alert as to whether the information pertinent to a printed image, such as addressee information, apparent in the image scan data, such as indicia scan data, does not match the information pertinent to images to be printed in the future, such as intended recipient information. As such the indicator 181 may be an electromagnetic or other signal directed by the governing protocol of the processor to in some way provide warning that the printed image, such as postage indicia, is not authenticated against to be printed images having information such as intended recipient information. Accordingly, for example, where there is a mismatch between intended recipient information and previously printed addressee information in a printed postage indicia, then the amber light may light up to warn and operator of the problem. Those in the art should appreciate that the manifestation of the indicator may be visual via lights, or depicted on computer displays, or audible via sirens or beeps, or may provide warning in some other acceptable manner.

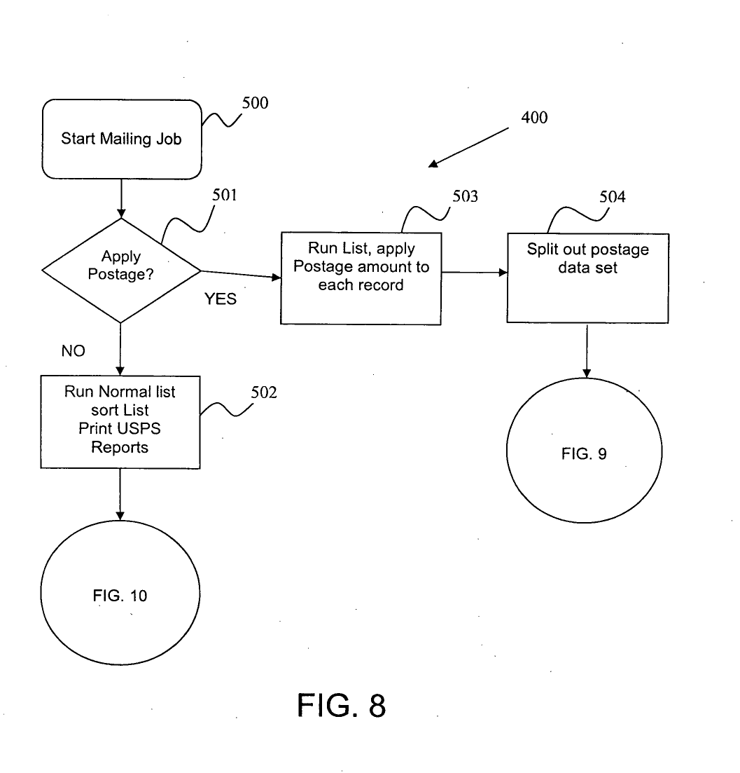

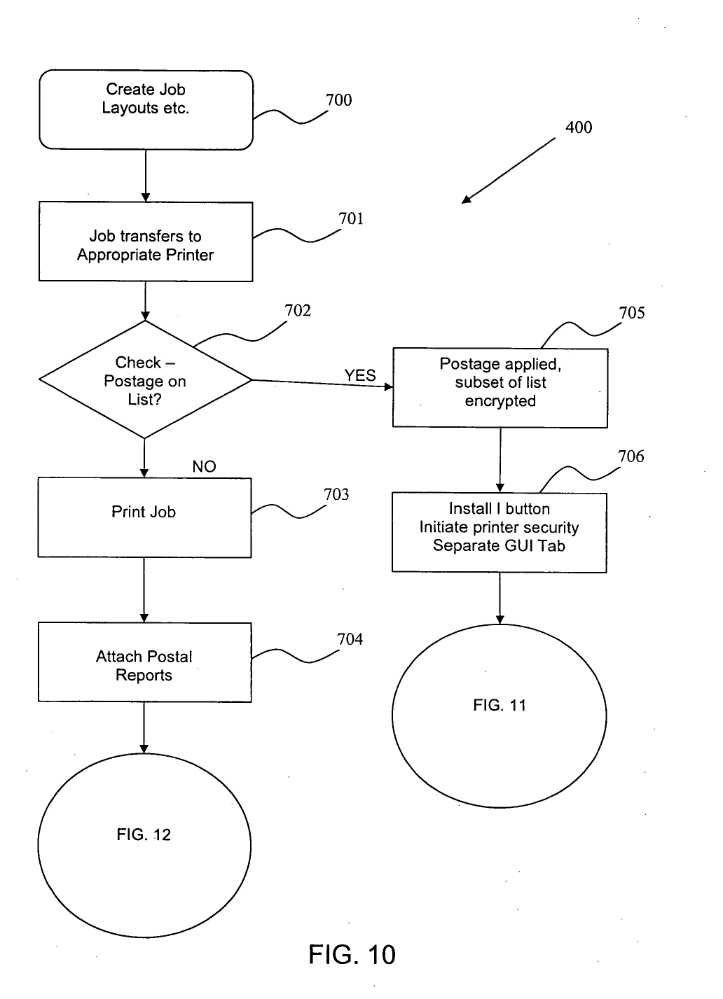

A printing method 400 is now described with reference to FIGS. 1-12. By way of example, the method 400 is described in relation to printing postage on mail pieces. However, those in the art should appreciate that the method 400 may apply to other print jobs. For example, the method 400 may be applied to the printing of images containing information relative to credit cards, wherein addressee information of postage indicia and intended recipient information may correspond to information and images typically printed on a credit card. An embodiment of methodology relative to the initiation of exemplary postage printing is depicted in a flow chart in FIG. 8, showing as a first step, the starting of a mailing job 500. The starting of a mailing job may include obtaining a data set, wherein the data set may include postage data and mail destination data. Here again, those in the art should appreciate that the data set may include credit card holder information or other information pertinent to other print jobs. Once obtained, that data set may be manipulated. For example, postage may or may not be applied to the data set 501. If postage is not applied to the data set, then a normal mail list may be run 502. The list may be sorted and associative USPS reports may be printed. Moreover, the printing may be continued with methodology to be described later in relation to FIG. 10. However, if the postage is to be applied, then a mail list may be run applying a postage amount to each record on the list. The postage data set may then be split out from the mail destination data set 504.

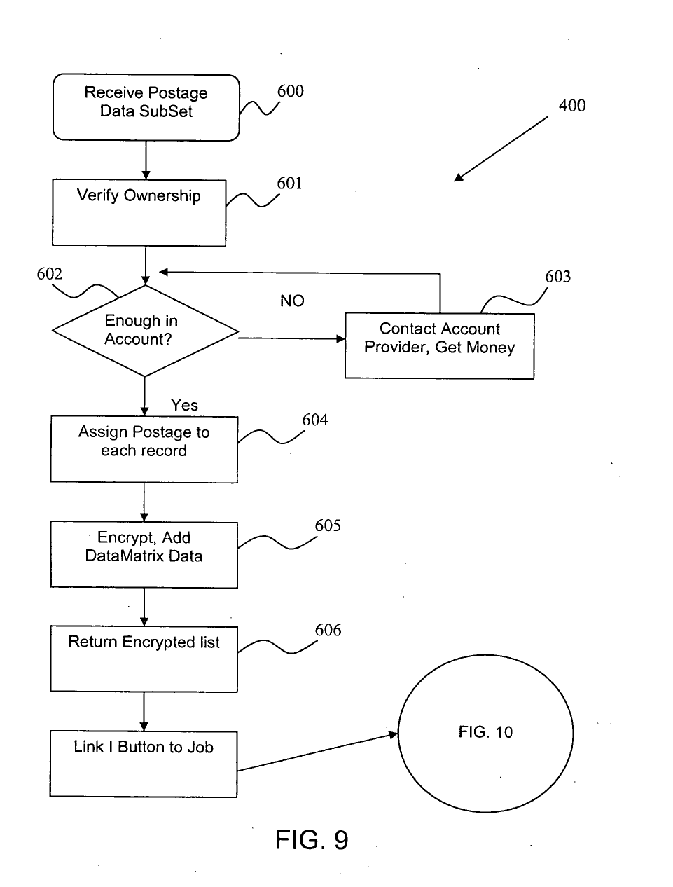

Once split out, as shown in FIG. 9, the postage data set may be received 600 preparatory to manipulating postage indicia data correlative to postage printing. Part of the manipulation may be to verify correct ownership 601 of the postage and mail destination data sets and information. Once ownership is verified, a determination can be made as to whether the owner has enough monetary credit in an account 602 to cover postal charges for postage to be printed. If it is determined that there is not enough monetary credit, then the owner may be directed to contact an account provider get/give the necessary money 603 or monetary credit associated with the postage to be printed. Once it is determined that there is enough monetary credit in, then actual postage may be assigned to each record 604. As the postage is assigned or following its assignment, an encryption step may be implemented to protect the information, such as the act of adding DataMatrix data 605. Then the encrypted list of postage data may be returned 606 and an I Button may be linked to the corresponding postage print job 607.

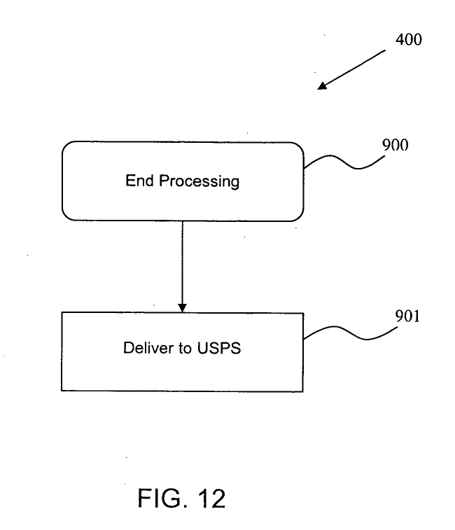

Regardless of whether postage is applied previous to printing or not, further printing methodology as embodied in a flow chart depicted in FIG. 10 may include creating job layouts 701 and preparing data for translation into printing. Once created, the print jobs may be sent or transferred to correct or appropriate printers or imagers, such as imagers 190a-d. Then a check 702 can be performed to see whether postage charges have been applied to the print data or job list. If postage is not affirmatively provided on the list data, the print job may be printed 703 and Postal Reports may accordingly be attached 704 in preparation for accomplishment of additional methodology embodied and discussed in greater detail in relation to FIG. 12. However, if the check 702 determines that postage has been applied to the list data, then determinations can be made to see whether the postage data and/or subsets of the postage data have been encrypted 705. Following the determinations an I Button 184 may be installed 706 to assist in the initiation of printer 100 security and possibly to activate the separation of a GUI tab. The I Button 184 may be a programmable secure item that, when installed or inserted into the printing apparatus 100, may facilitate secure printing/verifying functions. A print job may be linked or associated with the function of the I Button 184, such that when the print job is returned with encrypted postage 705, printer security may be initiated via the I Button 184, such as by a directive proffered by a separate GUI tab. The GUI may be software or protocol that provides an on screen interface, such as a touch tab, accessible by a user/operator, wherein the interface may provide for instruction and/or command function to initiate secure printing. The I Button 184 may have been pre-programmed to contain print job information. Moreover, the I Button may have been formatted to save job records for storage and accounting purposes. In addition, the I Button 184 may operate with the governing protocol of the processor of the computer 170 of the printing apparatus 100, such that when a print job is done the I Button 184 may be rendered useless until it is refilled with a new security-enabled print job. Often it is critical that information to be printed be secured. For example, the USPS may dictate that print data be encrypted. The I Button 184 may operate to provide a key necessary for decrypting secured data. Furthermore, if a print job of printing apparatus 100 is interrupted, the information necessary to move the print job to a different functionally competent printing apparatus may be contained in the I Button 184. For example, the different printing apparatus may start up the print job where the previous printing apparatus 100 left off with the insertion of the I Button 184 into the different print apparatus. Accordingly, it may be possible to perform different portions of a print job on different comparable printing devices by moving the I Button 184 from one printing device to the other and continuing the print job. All functionality pertinent to the I Button 184, following its installation 706 on a printing apparatus 100, may be controlled through the GUI or user interface software.

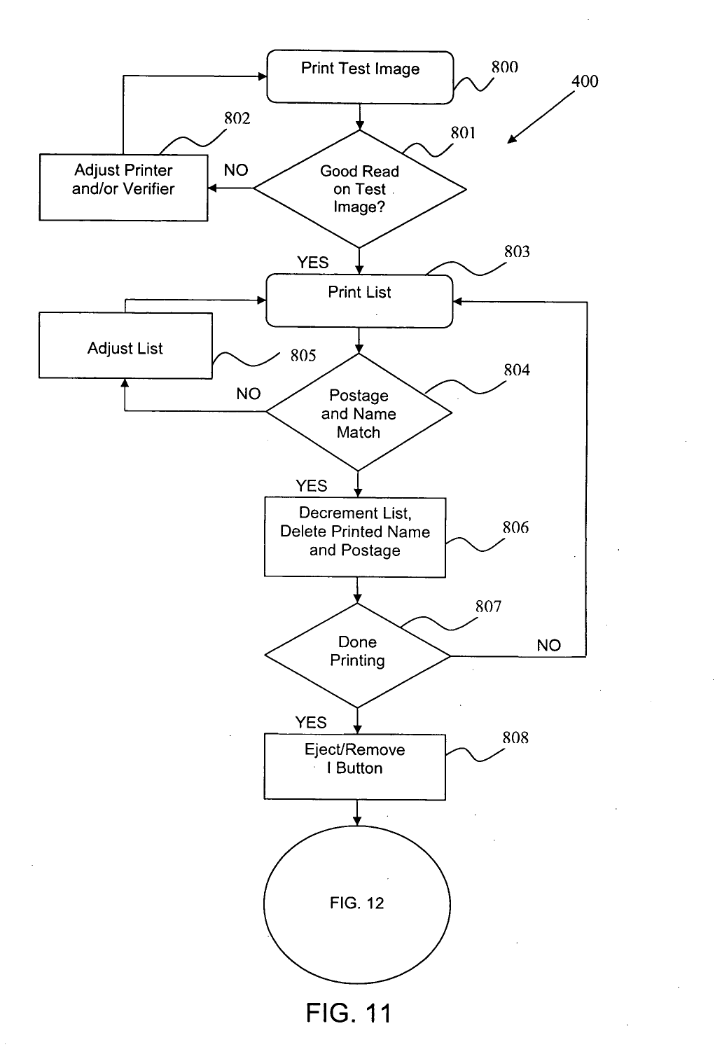

Referring to FIG. 11, a flow chart of an embodiment of methodology for printing is depicted including a step of commencing to print a test image 800. Printing of a test image 800 may include printing an image that may contain information to be scanned. For example, the test image may be postage indicia including addressee information. Once a test image, such as postage indicia, has been printed 800, a next step may be to see whether there is a good read on the test image 801, which may include verifying whether the image accurately depicts information intended to be printed. For example, a test image, such as postage indicia printed on a mail piece, may be scanned to see if it accurately depicts any included addressee information that may be apparent in the postage indicia image. If there is not good read on the image, for instance, if it is determined that the printed postage indicia does not accurately determine the addressee information, then the printer or imager(s), such as imager 190a-d, may be adjusted 802 to accurately print postage indicia on a mail piece which verifiably corresponds to intended recipient information. Moreover, the verifier may also be adjusted to make sure it is accurately scanning the image. Then the process may be repeated again to see if there is a good read 801. If there is a good read 801, then a step may be to print the list 803. Printing of the list 803 may include the printing of a stored image on material to be printed on, such as printing postage indicia on a mail piece, wherein said postage indicia may include addressee information pertinent to the obtained postage data. A next step may be executed to compare 804 the verified information in the printed image, such as addressee information, with information to be printed in the future, such as intended recipient information included in corresponding mail destination data, to determine whether the information apparent in the image, such as addressee information apparent in the postage indicia, authentically matches 804 the intended information, such as recipient information, to be printed. If the comparison does not yield an identical match, then the list data set may be adjusted 805 to accurately print the images on materials to be printed on, such as printing postage indicia on a mail piece which verifiably corresponds to intended recipient information. The process may be repeated as many times as necessary to ensure that there is a good read 801 and authentic match 804. Once there is a good read 801 and an authentic match 804, then the list data set may be decremented to print 806 only the authenticated images intended to be printed, such as printing only authenticated intended recipient information on the mail piece. Moreover, as each image data record, such as an image data record including postage data for postage indicia having addressee information and mail destination having intended recipient data, is printed the data record may be subsequently deleted. Printing may continued until all data records have been deleted and printing is done 807. Once printing has completed, the I Button 184 may be removed or ejected from the printing apparatus 100.

As depicted in FIG. 12, following the completion of printing all intended images the printing process may terminate 900. For example the printing of a list of postage indicia having addressee information corresponding to intended recipient information may end 900. Once all printing has been accomplished on materials to be printed, the materials may be taken to a new location 901. For example, the mail pieces having printed postage and intended recipient information may be delivered to the USPS 901. However, additional printing methodology may also include verifying whether the intended recipient information printed on the mail piece is accurately depicted. Furthermore, the printing method may include indicating whether the images having information, such as addressee information included in the postage indicia printed on the mail piece, does not match corresponding information intended to be printed, such as intended recipient information to correspondingly be printed on the same mail piece. Moreover, further methodology may include prohibiting printing of future images, such as intended recipient information on the mail piece, if previously printed images, such as addressee information included in the printed postage indicia, has not been authenticated.

With additional reference to the drawings, FIGS. 1-12 depict a postage printing system, which may include a printing apparatus 100 having an imager 190c and a verifier 180, wherein the printing apparatus 100 may print 800 images, such as postage indicia, on a material to be printed, such as a mail piece, wherein said images may include information, such as the postage indicia may include addressee information. Moreover the postage printing apparatus may verify 801 whether the postage indicia printed on the mail piece accurately depicts the addressee information. Furthermore, the postage printing apparatus may compare 803 the verified addressee information with intended recipient information to be printed on the mail piece. Additionally the printing apparatus 100 may print 805 the intended recipient information on the mail piece if it matches the compared verified addressee information. Still further the postage printing system may include a printing apparatus 100 that may determine whether a postage charge corresponding to the postage indicia to be printed has been properly paid for 602. Even further still, the printing apparatus 100 may check whether addressee information has been encrypted 702.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

I claim:

1. A postage printing apparatus comprising:
a processor including governing protocol executable for imaging and verifying;
an input, communicatively operable with the processor and configured to receive data pertaining to postage indicia and corresponding mail destination information, said postage indicia including addressee information and said mail destination information including intended recipient information;
a first imager, configured to print postage indicia on a mail piece as directed by the governing protocol of the processor;
a verifier, configured to scan postage indicia printed by the imager on the mail piece and communicate indicia scan data to the processor, wherein the processor executes the governing protocol to evaluate the indicia scan data to determine if addressee information is apparent in the indicia scan data and to compare apparent addressee information with corresponding intended recipient information included in the mail destination information inputted to the processor to confirm that the addressee information matches the intended recipient information;
a second imager, configured to print mail destination information as directed by the governing protocol of the processor only following said processor's confirmation that the addressee information apparent in the indicia scan data matches intended recipient information; and
an indicator, operable with the processor and configured to provide an alert as to whether the addressee information apparent in the indicia scan data does not match the intended recipient information.

2. The postage printing apparatus of claim 1, further comprising a mail piece transporter.

3. The postage printing apparatus of claim 1, further comprising a control panel.

4. The postage printing apparatus of claim 3, wherein the indicator is manifest as a light located on the control panel.

5. The postage printing apparatus of claim 3, wherein the control panel further includes a mail piece movement adjustment knob, an on/off button and corresponding on and off lights.

6. The postage printing apparatus of claim 1, further comprising a display monitor.

7. The postage printing apparatus of claim 1, further comprising a print product sensing system including an encoder assembly.

8. The postage printing apparatus of claim 1, wherein the input is selected from the group consisting of a keyboard, a mouse, a GUI interface, a wireless port, a hardline port, and a drive capable of reading retrievable media.

9. The postage printing apparatus of claim 1, wherein the processor is housed in a computer.

10. The postage printing apparatus of claim 1, further comprising an I Button.

11. The postage printing apparatus of claim 3, wherein the I Button is located on the control panel.

12. The postage printing apparatus of claim 10, wherein the control button operates with the governing protocol to facilitate secure printing.

13. A postage printing method comprising:
obtaining a data set, said data set including postage data and mail destination data;
printing postage indicia on a mail piece, wherein said postage indicia includes addressee information pertinent to the obtained postage data;
verifying whether the postage indicia printed on the mail piece accurately depicts the addressee information;
comparing the verified addressee information with intended recipient information included in corresponding mail destination data to determine whether the addressee information authentically matches the intended recipient information; and
printing only the authenticated intended recipient information on the mail piece.

14. The postage printing method of claim 10, further comprising verifying whether the intended recipient information printed on the mail piece is accurately depicted.

15. The postage printing method of claim 10, further comprising encrypting the postage data.

16. The postage printing method of claim 10, further comprising determining whether there is enough money in an account to pay for postage.

17. The postage printing method of claim 10, further comprising indicating whether the addressee information included in the postage indicia printed on the mail piece does not match corresponding intended recipient information to be printed on the same mail piece.

18. The postage printing method of claim 10, further comprising prohibiting printing of intended recipient information on the mail piece if previously printed addressee information included in the printed postage indicia has not been authenticated.

19. The postage printing method of claim 10, further including sorting the obtained data set.

20. The postage printing method of claim 15, further including adjusting a printer to accurately print postage indicia on a mail piece which verifiably corresponds to intended recipient information.

21. The postage printing method of claim 15, further including adjusting the data set to accurately print postage indicia on a mail piece which verifiably corresponds to intended recipient information.

22. A postage printing system comprising:
a printing apparatus having an imager and a verifier, wherein the printing apparatus performs the steps of:
printing postage indicia on a mail piece, wherein said postage indicia includes addressee information;
verifying whether the postage indicia printed on the mail piece accurately depicts the addressee information;
comparing the verified addressee information with intended recipient information to be printed on the mail piece; and
printing the intended recipient information on the mail piece if it matches the compared verified addressee information.

23. The postage printing system of claim 19, wherein the printing apparatus further performs the steps of determining whether a postage charge corresponding to the postage indicia to be printed has been properly paid for and checking whether addressee information has been encrypted.

24. The postage printing system of claim 19, wherein postage indicia is included in an encrypted data set to facilitate secure printing.

25. The postage printing system of claim 19, wherein printing is non-secured.

26. A printing apparatus comprising:
a processor including governing protocol executable for imaging and verifying;
an input, communicatively operable with the processor and configured to receive data pertaining to first image information and second image information, said first image information pertaining to a first image and said second image pertaining to a second image;
a first imager, configured to print said first image on a material as directed by the governing protocol of the processor;
a verifier, configured to scan said first image printed by the imager on the material and communicate image scan data to the processor, wherein the processor executes the governing protocol to evaluate the image scan data to determine if first image information is apparent in the image scan data and to compare apparent first image information with corresponding second image information inputted to the processor to confirm that the apparent first image information matches the second image information;
a second imager, configured to print a second image as directed by the governing protocol of the processor only following said processor's confirmation that the first image information apparent in the image scan data matches second image information; and
an indicator, operable with the processor and configured to provide an alert as to whether the first image information apparent in the image scan data does not match the second image information.
